(19) United States
(12) Patent Application Publication
(10) Pub. No.: US 2005/0066860 A1
(43) Pub. Date: Mar. 31, 2005

(54) Use of organic waste/mineral by-product mixtures in cement manufacturing processes

(76) Inventors: Terry J. Logan, Hilton Head Island, SC (US); Ervin L. Faulmann, Toledo, OH (US); Tim Nicholson, Toledo, OH (US)

Correspondence Address: KENYON & KENYON, 1500 K STREET, N.W., SUITE 700, WASHINGTON, DC, 20005, US

(21) Appl. No.: 10/669,463

(22) Filed: Sep. 25, 2003

(51) Int. Cl. C01B 21/00; C04B 2/10; C04B 7/45; C04B 11/036

(52) U.S. Cl. 106/745; 423/235; 106/758; 106/763; 106/764

(57) ABSTRACT

The use of organic waste/mineral by-product mixtures as raw materials in the manufacture of cement clinker; as alternative or supplemental fuel sources for heating a kiln used in a cement clinker manufacturing process; and, to reduce nitrogen oxide (NOₓ) emissions generated during cement manufacturing processes are disclosed.

### FIELD OF THE INVENTION

The present invention is generally directed to the use of organic waste/mineral by-product mixtures in cement manufacturing processes. More particularly, the present invention is directed to the use of organic waste/mineral by-product mixtures as raw materials in the manufacture of cement clinker; as alternative or supplemental fuel sources for heating a kiln in a cement clinker manufacturing process; and, to reduce nitrogen oxide (NOₓ) emissions generated during cement manufacturing processes.

### BACKGROUND OF THE INVENTION

Mineral by-products have been used in stabilizing semi-solid, odorous organic waste through bulk drying, odor absorption, and granulation. See, e.g., U.S. Pat. Nos. 4,554,002, 4,902,431 and 4,781,842, each of which is incorporated herein by reference in its entirety. Organic waste treated in accordance with such methods includes, e.g., sludges from municipal wastewater treatment facilities. The treatment of such organic wastes with mineral by-products can reduce pathogens and volatile organic materials. The resultant product, which is relatively dry and easily handled, has a high organic content and is suitable for as use, inter alia, as a soil conditioner or fertilizer. This product, particularly when the organic content derives from wastewater treatment sludges and other potentially pathogenic sources, is referred to as “stabilized sludge” in the sense that the sludge has been treated to reduce pathogens and odorous volatile organic compounds.

Mineral materials and by-products such as sand, diatomaceous earth, perlite, and various mineral reagent powders have also been used in conjunction with the fluidized heating, drying and burning of sludges and oily waste. See, e.g., U.S. Pat. Nos. 4,159,682, 4,787,323, 4,970,803 and 5,490,907, each of which is incorporated herein by reference in its entirety.

Cement manufacturing processes produce mineral by-products, such as cement kiln dust, that have been combined with organic wastes to produce organic waste/mineral by-product mixtures or stabilized sludges, such as discussed above. Cement kiln dusts are particularly useful in the treatment and stabilization of organic wastes because of the alkaline components, such as lime, typically present therein. The alkaline components can react with water in the sludges to generate heat and elevate pH, both of which are beneficially used for pathogen and odor control in such wastes.

Cement manufacturing processes are very energy intensive because the kilns used to manufacture the cement clinker operate at temperatures typically around 1500° C. or greater. Moreover, because of the high operating temperatures of cement kilns, clinker manufacture generates nitrogen oxides (NOₓ) that are harmful to the environment.

It would, therefore, be desirable to develop new uses of organic waste/mineral by-product mixtures in cement manufacturing processes.

### SUMMARY OF THE INVENTION

The present invention is directed to the use of organic waste/mineral by-product mixtures, such as stabilized sludges, in cement manufacturing processes. In one embodiment, the present invention is directed to the use of organic waste/mineral by-product mixtures as alternative or supplemental fuel sources for heating a kiln used in a cement clinker manufacturing process. In another embodiment, the present invention is directed to the use of organic waste/mineral by-product mixtures as raw materials in the manufacture of cement clinker. In yet another embodiment, the present invention is directed to the use of ammonia liberated from organic waste to reduce nitrogen oxide (NOₓ) emissions generated during cement manufacturing processes. In preferred embodiments, the ammonia is liberated upon forming an organic waste/mineral by-product mixture and/or upon heating the organic waste/mineral by-product mixture.

In preferred embodiments of the invention, the mineral by-product is a coal combustion by-product comprising one or more materials selected from the group consisting of fly ash, bottom ash, fluidized bed ash, boiler slag and flue gas desulfurization by-products. In some embodiments, the organic waste/mineral by-product mixture will comprise an alkaline material, which may be present in addition to the mineral by-product. In preferred embodiments, the alkaline material comprises one or more materials selected from the group consisting of lime, calcium hydroxide, limestone, cement kiln dust and lime kiln dust. The mineral by-product itself may be alkaline. In preferred embodiments, the organic waste/mineral by-product mixture has a solids content of at least about 50% w/w, preferably at least about 75% w/w, more preferably, at least about 90% w/w or higher. The organic waste/mineral by-product mixture may be dried to achieve the preferred solids content. In preferred embodiments, the organic waste comprises a material selected from the group consisting of dewatered sewage sludge filter cake, animal manure, pulp and paper waste, fermentation waste, shredded paper and cardboard, food waste and other municipal, agricultural and/or industrial organic waste.

These and other embodiments of the present invention are described in more detail below.

### DETAILED DESCRIPTION OF THE INVENTION

The present invention will now be described in detail with regard to specific preferred embodiments of the invention. It is understood that the described embodiments are intended only as illustrative examples and, therefore, that the invention is not to be limited thereto.

The treatment and disposal of organic waste presents a continuing challenge for society. Depending on the nature of the organic waste, it may need to be treated to render it safe for use in various post-treatment applications, including even simple disposal in landfills. Such wastes include, for example, municipal wastewater treatment sludge and animal manures. Such treatments, as discussed above, include stabilization of the organic waste by mixing such waste with one or more mineral by-products, such as alkaline mineral by-products, to generate heat, dewater the sludge and elevate pH.

Industrial processes, such as cement manufacturing processes, generate substantial quantities of mineral by-products that can be beneficially mixed with organic waste for such purposes. For example, cement kiln dust (“CKD”), is a by-product generated during the manufacture of cement clinker. CKD contains free lime and, therefore, is a useful source of alkalinity in the stabilization of organic wastes.

The present invention provides for novel uses of organic waste/mineral by-product mixtures, such as stabilized sludges, in cement manufacturing processes. The organic waste/mineral by-product mixture produced by combining organic waste with one or more mineral by-products is high in organic content and, therefore, has considerable value as a fuel source. In particular, mixing of organic waste and one or more mineral by-products can produce a relatively dry mixture, which renders the mixture amenable to burning to release the caloric value from the organic material. Because cement kilns typically operate at temperatures of about 1500° C. or greater, cement manufacturing processes are very energy intensive and require substantial quantities of fuel. In one embodiment of the present invention, the organic waste/mineral by-product mixture is used as a source of fuel for heating the cement kiln.

In another embodiment, the organic waste/mineral by-product mixture can be combined with the raw feed to the kiln in cement clinker manufacturing. The physical and chemical characteristics of the organic waste/mineral by-product mixture render it valuable as feedstock, preferably used to supplement other raw materials typically present in cement clinker raw feed.

Certain sources of organic waste have a high content of nitrogen, for example, present in the form of bound ammonia. Mixing of organic waste with mineral by-products, particularly alkaline mineral by-products (or other alkaline material), can cause the ammonia to be released from the organic waste. Ammonia can also be released from a mixture of organic waste and a mineral by-product by heating that mixture.

Because of the high temperatures used in cement manufacturing processes, these processes can produce substantial quantities of nitrogen oxides (NOₓ), which are harmful to the environment. It is known that ammonia or urea can react with NOₓ to generate nitrogen gas. Thus, ammonia can be used to reduce NOₓ emissions from exhaust gases. For example, gaseous ammonia, in the form of commercial anhydrous ammonia and its main derivative, urea, are currently used in treating fossil fuel combustion exhausts for NOₓ removal. Commercial sources of ammonia and urea are expensive. Thus, in another embodiment of the present invention, ammonia liberated from an organic waste is used to reduce nitrogen oxide (NOₓ) emissions generated during cement manufacturing processes. In preferred embodiments, the ammonia is liberated upon forming an organic waste/mineral by-product mixture and/or upon heating the organic waste/mineral by-product mixture.

Non-limiting examples of organic waste used in the processes of the present invention include, but are not limited to, municipal wastewater treatment sludges such as dewatered sewage sludge filter cake, various animal manures, pulp and paper waste, fermentation waste, shredded paper and cardboard, food waste (such as food processing waste), and other municipal, agricultural and/or industrial organic waste, and mixtures thereof. In particular, organic waste such as sewage sludges, animal manures, fermentation biomass, and some food waste are high in protein and ammonia, and thus, are preferred in embodiments of the present invention that involve liberating ammonia from the waste for use to reduce NOₓ in the cement kiln exhaust gases. In general, though, the organic waste can be from any source and of any type.

Non-limiting examples of mineral by-products that are mixed with the organic waste to form the organic waste/mineral by-product mixtures include coal combustion by-products such as fly ash, bottom ash, fluidized bed ash and flue gas desulfurization by-products. Mineral by-products may include alkaline materials such as lime (CaO), calcium hydroxide (Ca(OH)₂), and limestone, as calcite (CaCO₃) or dolomite (CaMg(CO₃)₂), limestone and mixtures thereof. Cement kiln dust, lime kiln dust and flue gas desulfurization by-products are alkaline by-products familiar to those skilled in the art, many of which are commercially available. Cement kiln dust and coal combustion by-products are preferred mineral by-products for use in the present invention.

Fly ashes are the mineral residues of burning coal for electricity generation. Fly ash can be collected from the smoke stack of a burner (or furnace) by bag houses, electrostatic precipitators, or in down washes. Fly ashes have variable fineness, solids content, and chemical composition. Preferable fly ashes for use in the present invention are dry ashes. The chemical composition of ash depends on the type of coal that is burned. For example, coals from the western U.S. are typically high in calcium and thus, may contain a higher lime content than coals from the eastern U.S. Eastern coals are often higher in pyrite (FeS₂), which oxidizes on burning to SO₂, producing an acidic fly ash. Fly ashes are high in silicon, and are often in the form of a spherical glass. Some fly ashes are high in residual carbon in the form of charcoal and these are effective in absorbing biosolids odors.

Fluidized bed ash (FBA) refers to ash that is produced in a fluidized bed burner, in which a mixture of pulverized coal and limestone is burnt as a suspended, i.e., fluid mass. In this process, the limestone reacts with SO₂ produced from the oxidation of pyrite in the coal.

Flue gas desulfurization by-products (FGD) is a general term referring to a range of products formed when lime or limestone is used to remove SO₂ produced from the oxidation of pyrite in the coal. FGDs may be pure gypsum (CaSO₄.2H₂O), anhydrite (CaSO₄), or CaSO₃. FGDs may also contain fly ash, unburned carbon and unreacted lime.

The term “organic waste/mineral by-product mixture” as used herein refers to a product produced by intimately mixing organic waste with one or more mineral by-products. The organic waste/mineral by-product mixture is a distinct product. That is, upon mixing the organic waste with the mineral by-product and, after any further optional step(s), such as drying of the mixture, the resultant product can be stored, handled or utilized as a separate product.

Prior to mixing the organic waste and mineral by-product, it may be desirable to reduce the water content of the organic waste component by, for example, conventional means such as filtration or centrifugation. The organic waste and mineral by-product can then be mixed using conventional means. The organic waste/mineral by-product mixture will typically have a solids content of preferably at least 50% solids, more preferably at least 75% solids, even more preferably at least 90% solids. In some cases the organic waste/mineral by-product mixture will have a solids content of at least 95%, preferably as near 100% solids as possible.

To attain these solid contents, it may be desirable to subject the organic waste/mineral by-product mixture to a drying step. It is understood, however, that drying is not necessary for all types of organic waste. For example, some poultry manures include 70% or more solids. Drying of the organic waste/mineral by-product mixture can be conducted using conventional methods.

The mineral content of the organic waste/mineral by-product mixture will preferably be in the range of from about 25% to about 75% w/w, more preferably from about 30% to about 60% w/w, even more preferably from about 40% to about 50% w/w.

In some embodiments, particularly where the mineral by-product is an alkaline mineral by-product such as lime, cement kiln dust or alkaline fly ash, the organic waste/mineral by-product mixture will have an alkaline pH. Where the organic waste/mineral by-product mixture is alkaline, the pH will typically be in the range of from about 9 to about 12.5. In some preferred embodiments, the pH of the organic waste/mineral by-product mixture will be at least about 9.5, preferably at least about 10.

The use in cement manufacturing processes of organic waste/mineral by-product mixtures as described above will now be discussed.

Cement is manufactured by blending limestone with clay and other mineral ingredients such as sand and iron (such as iron ore or finely ground steel slag) to create a raw feed. The raw feed is introduced into a rotating drum kiln. The temperature of the kiln is high enough to calcine the limestone and to melt the calcined mixture. The melt is cooled as it exits the kiln and precipitates as clinker. Clinker is finely ground with a small amount of gypsum to produce cement.

There are two basic types of cement manufacturing processes: the wet process and the dry process. In the wet process, the raw material is blended with water to produce a slurry which is pumped directly into the cold end of the kiln. The slurrying process helps homogenize the material. The wet process is the most energy intensive, because the water must be evaporated out of the slurry mixture.

In the dry kiln process, the raw material enters the kiln in a dry powdered form. Three types of kilns utilize the dry process. The preheater kiln features a tower of heat-exchanging cyclones. The raw material enters the pre-heater in a dry powdered form where it is pre-heated by the hot exit gases from the kiln prior to entering the kiln chamber. The pre-calciner kiln is identical to the pre-heater kiln except that a separate combustion gas inlet at the base of the preheater promotes further calcination of the material before entering the kiln. The third type of kiln is referred to as the long dry kiln and feeds dry raw material directly into the upper end of the kiln.

Cement kilns are basically tilted rotating cylinders lined with heat-resistant bricks. The raw feed material mixture is fed into the higher, elevated or “cool” end of the kiln. As the kiln slowly rotates, the raw meal tumbles down toward the hot lower, or “flame” end, gradually altering physically and chemically in the intense heat to form clinker.

The extraordinarily high temperatures involved in producing cement require large amounts of energy. Manufacturing one ton of cement requires an average of 4.4 million Btu—roughly equal to 400 pounds of coal. Cement kilns use coal, oil, petroleum coke, natural gas, or hazardous waste fuel. Most cement kilns burning hazardous waste use it to supplement—rather than replace—conventional fuel.

Waste fuels include waste oil, paints, solvents, and shredded tires.

Fine particles are formed in the kiln from the raw feed and are entrained in the heated air in the kiln. These particles are recovered from the kiln in precipitators or bag houses as cement kiln dust (CKD). CKD may be wasted, utilized as a saleable commodity, or recycled back into raw feed.

The high temperatures in cement kilns (as high as 1500° C. or greater) result in the formation of NOₓ, which is a product of the thermal oxidation of nitrogen gas in the combustion air. Cement kilns use a variety of methods to minimize NOₓ production, including injection of ammonia.

In one embodiment of the present invention, the organic waste/mineral by-product mixture is used as a fuel to heat the kiln for clinker manufacture. Preferably, the organic waste/mineral by-product mixture is used as a supplemental fuel and, therefore, is combined with other fuels such as coal, pet coke, shredded tires or other solid fuel commonly used for heating cement kilns. The use of the organic waste/mineral by-product mixture as a cement kiln fuel is beneficial, inter alia, in that it disposes of organic waste that might otherwise be sent to a landfill and reduces utilization of other fuels such as fossil fuels.

In another embodiment, the present invention is directed to the reduction of NOₓ emissions from cement kiln exhaust gases. NOₓ emissions from cement kilns are a source of environmental pollution. For example NOₓ increases atmospheric ozone levels and both NOₓ and ozone are lung irritants. Moreover, NOₓ reacts with atmospheric water to produce nitric acid, thus exacerbating the “acid rain” problem. Among methods used to reduce NOₓ comprise contacting the kiln exhaust gases with anhydrous ammonia or urea to convert the NOₓ into nitrogen gas. Ammonia and urea are expensive reagents. Therefore, it would be desirable to provide a less expensive source of ammonia for reducing NOₓ in cement kiln exhaust gases.

Organic wastes may contain substantial quantities of ammonia that can be liberated from the organic waste, for example, upon mixing of the organic waste with a mineral by-product, such as an alkaline mineral by-product or upon heating an organic waste/mineral by-product mixture. For example, mixing organic waste with an alkaline mineral by-product, such that the mixture has a pH of about 9.5-10 or greater, can liberate ammonia from the organic waste. This liberated ammonia may be contacted with the cement kiln exhaust gas to reduce NOₓ therein. Ammonia can be liberated outside of the kiln (ex-situ) by, for example, by mixing the organic waste with the mineral by-product to form the organic waste/mineral by-product mixture.

The ammonia may also be liberated directly in the kiln from the organic waste/mineral by-product mixture fed to the kiln as a fuel. In this case, the ammonia is released by heating the organic waste/mineral by-product mixture. Where the ammonia is liberated directly in the kiln, the organic waste/mineral by-product mixture is preferably fed mid-kiln, where the lower temperatures are more conducive to NOₓ reduction. In either case, the liberate ammonia reacts with NOₓ emissions from the cement kiln to generate innocuous nitrogen gas. The ammonia liberated from the organic waste may supplement the use of commercial anhydrous ammonia or urea to reduce NOₓ in the cement kiln exhaust gases.

In another embodiment, the present invention is directed to the use of an organic waste/mineral by-product mixture in the raw feed to the cement kiln. The raw feed in cement clinker manufacture typically comprises a mixture of limestone, clay and other mineral additives, such as iron oxide. Because of its mineral content, the organic waste/mineral by-product mixture can be used as a substitute for some portion of the clay and/or limestone in the raw feed. For example, use of an organic waste/mineral by-product mixture having a high content of lime from, for example, cement kiln dust, can reduce the amount of limestone needed in the raw feed. Thus, the cement kiln dust, which would otherwise by a wasted by-product from the cement manufacture, is recycled to the clinker manufacture in the form of the organic waste/mineral by-product added to the raw feed. Similarly, use of an organic waste/mineral by-product mixture where the mineral by-product is fly ash, can reduce the amount of the clay component needed in the raw feed.

Where a portion of the raw feed comprises the organic waste/mineral by-product mixture, it is preferable that the amount of the organic waste/mineral by-product mixture be in the range of from about 10% to about 50% w/w, more preferably from about 10% to about 30% w/w, even more preferably from about 10% to about 20% w/w, based on the total weight of the raw feed.

Although the present invention has been described by several embodiments, various changes and modifications may be suggested to one skilled in the art. It is intended that the present invention encompass such changes and modifications as fall within the scope of claims appended hereto.

1. A method of heating a kiln used in the manufacture of cement clinker comprising burning a fuel comprising an organic waste/mineral by-product mixture.

2. The method of claim 1 wherein said mineral by-product is a coal combustion by-product comprising one or more materials selected from the group consisting of fly ash, bottom ash, fluidized bed ash, boiler slag and flue gas desulfurization by-products.

3. The method of claim 1 wherein said organic waste/mineral by-product mixture comprises an alkaline material.

4. The method of claim 3 wherein said alkaline material comprises one or more materials selected from the group consisting of lime, calcium hydroxide, limestone, cement kiln dust and lime kiln dust.

5. The method of claim 1 wherein said fuel further comprises one or more materials selected from the group consisting of coal, pet coke, oil, natural gas and hazardous waste.

6. The method of claim 5 wherein said fuel further comprises pet coke.

7. The method of claim 1 wherein said organic waste/mineral by-product mixture has a solids content of at least about 50%.

8. The method of claim 1 wherein said organic waste/mineral by-product mixture has a solids content of at least about 75%.

9. The method of claim 1 wherein said organic waste/mineral by-product mixture has a solids content of at least about 90%.

10. The method of claim 1 wherein said organic waste comprises a material selected from the group consisting of dewatered sewage sludge filter cake, animal manure, pulp and paper waste, fermentation waste, shredded paper and cardboard, and food waste.

11. The method of claim 1 wherein said organic waste/mineral by-product mixture has a pH of at least about 9.5.

12. A raw feed for use in forming cement clinker comprising limestone, clay and an organic waste/mineral by-product mixture.

13. The raw feed of claim 12 wherein said mineral by-product is a coal combustion by-product comprising one or more materials selected from the group consisting of fly ash, bottom ash, fluidized bed ash, boiler slag and flue gas desulfurization by-products.

14. The raw feed of claim 12 wherein said organic waste/mineral by-product mixture comprises an alkaline material.

15. The raw feed of claim 14 wherein said alkaline material comprises one or more materials selected from the group consisting of lime, calcium hydroxide, limestone, cement kiln dust and lime kiln dust.

16. The raw feed of claim 15 wherein said alkaline material comprises cement kiln dust.

17. The raw feed of claim 12 wherein said organic waste/mineral by-product mixture has a solids content of at least about 50%.

18. The raw feed of claim 12 wherein said organic waste/mineral by-product mixture has a solids content of at least about 75%.

19. The raw feed of claim 12 wherein said organic waste/mineral by-product mixture has a solids content of at least about 90%.

20. The raw feed of claim 12 wherein said organic waste comprises a material selected from the group consisting of dewatered sewage sludge filter cake, animal manure, pulp and paper waste, fermentation waste, shredded paper and cardboard, and food waste.

21. The raw feed of claim 12 wherein said organic waste/mineral by-product mixture has a pH of at least about 9.5.

22. A method for reducing NOₓ emissions from exhaust gases generated during the production of cement clinker comprising contacting said exhaust gases containing NOₓ with ammonia liberated from organic waste.

23. The method of claim 22 wherein said ammonia is liberated by raising the pH of said organic waste to at least about 9.5.

23. The method of claim 23 wherein the pH of the organic waste is raised to at

24. least about 9.5 by forming an organic waste/mineral by-product mixture.

25. The method of claim 24 further comprising drying said organic waste/mineral by-product mixture.

26. The method of claim 24 wherein said mineral by-product is a coal combustion by-product comprising one or more materials selected from the group consisting of fly ash, bottom ash, fluidized bed ash, boiler slag and flue gas desulfurization by-products.

27. The method of claim 24 wherein said organic waste/mineral by-product mixture comprises an alkaline material.

28. The method of claim 27 wherein said alkaline material comprises one or more materials selected from the group consisting of lime, calcium hydroxide, limestone, cement kiln dust and lime kiln dust.

29. The method of claim 28 wherein said alkaline material comprises cement kiln dust.

30. The method of claim 25 wherein said organic waste/mineral by-product mixture is dried to a solids content of at least about 50%.

31. The method of claim 25 wherein said organic waste/mineral by-product mixture is dried to a solids content of at least about 75%.

32. The method of claim 25 wherein said organic waste/mineral by-product mixture is dried to a solids content of at least about 90%.

33. The method of claim 22 wherein said organic waste comprises a material selected from the group consisting of dewatered sewage sludge filter cake, animal manure, pulp and paper waste, fermentation waste, shredded paper and cardboard, and food waste.
